(19) United States
(12) Patent Application Publication
(10) Pub. No.: US 2026/0368081 A1
(43) Pub. Date: Nov. 19, 2026

(54) MEMORY SPACE MANAGEMENT TECHNIQUES FOR REDUCING WRITE AMPLIFICATION IN MEMORY SYSTEMS

(71) Applicant: SK hynix Inc., Icheon-si (KR)

(72) Inventors: Nan Lu, San Jose, CA (US); Pengfei Huang, San Jose, CA (US)

(21) Appl. No.: 19/212,463

(22) Filed: May 19, 2025

(51) Int. Cl. G06F 12/02

(52) U.S. Cl. CPC G06F 12/0246; G06F 2212/7202

(57) ABSTRACT

Memory space management techniques for reducing write amplification are disclosed. In an embodiment, a method for managing a memory space in a memory system comprises: monitoring, by a memory system controller, a usage condition of the memory space; determining, by the memory system controller, a current wear level stage of the memory system, from among a plurality of predetermined memory wear stages; selecting, by the memory system controller, an error correction granularity level corresponding to the determined memory wear stage; and performing, by the memory system controller, an error correction operation based on the error correction granularity level.

### TECHNICAL FIELD

This patent document relates to memory space management and memory systems performing memory space management.

### BACKGROUND

Unlike hard disk drives (HDDs), solid-state drives (SSDs) do not support in-place writes, which necessitates garbage collection (GC) to reclaim blocks containing invalid data. This garbage collection process generates internal write traffic, which adversely affects host read quality of service (QoS) and throughput. Extensive research has been actively conducted to address this issue and to develop more efficient memory management techniques that minimize the negative impact of garbage collection.

### SUMMARY

Embodiments of the disclosed technology relate to methods and systems that, among other features and benefits, can provide memory space management techniques (e.g., solid-state drive (SSD) memory management, more particularly to NAND media space management techniques) for reducing write amplification (WA) through dynamic allocation of XOR and reserved (RSVD) spaces during the lifetime of the systems.

In one aspect, a method for managing a memory space in a memory system may include monitoring, by a memory system controller, a usage condition of the memory space;

determining, by the memory system controller, a current wear level stage of the memory system, from among a plurality of predetermined memory wear stages; selecting, by the memory system controller, an error correction granularity level corresponding to the determined memory wear stage; and performing, by the memory system controller, an error correction operation based on the error correction granularity level.

In another aspect, a method for managing a memory space in a memory system may include monitoring, by a memory system controller, a program-erase cycle (PEC) count of a memory block in the memory system; comparing, by the memory system controller, the PEC count with a first threshold value and a second threshold value greater than the first threshold value; selecting, by the memory system controller, an error correction granularity level based on the comparing, wherein the error correction granularity level is one of a wordline level, a plane level, or a die level; and allocating, by the memory system controller, a first functional memory space and a second functional memory space in the memory space based on the selected error correction granularity level.

In yet another aspect, a memory system may include a memory space including a plurality of functional memory spaces allocated for specific functionalities; and a controller in communication with the memory space to: monitor a usage condition of the memory space; determine a current wear level stage of the memory system, from among a plurality of predetermined memory wear stages; select an error correction granularity level corresponding to the determined memory wear stage; and perform an error correction operation based on the error correction granularity level.

### BRIEF DESCRIPTION OF THE DRAWINGS

FIG. 1 illustrates an example of a memory system that can be utilized for implementing some embodiments of the disclosed technology.

FIG. 2 is a schematic diagram illustrating an example of a memory system based on some embodiments of the disclosed technology.

FIG. 3A is a graph showing the increase in fail bit count (FBC) across program/erase cycle (PEC) stages. FIG. 3B is a graph showing the increase in grown bad blocks (GBBs) across program/erase cycle (PEC) stages.

FIG. 4 is a conceptual diagram of a wordline XOR scheme applied during the beginning-of-life (BOL) PEC stage.

FIG. 5 is a conceptual diagram of a plane XOR scheme applied during the middle-of-life (MOL) PEC stage.

FIG. 6 is a conceptual diagram of a die XOR scheme applied during the end-of-life (EOL) PEC stage.

FIG. 7 is a flowchart illustrating a method of dynamically managing XOR space in accordance with PEC progression.

FIG. 8 is a flowchart illustrating a method of dynamically managing reserved (RSVD) space for bad blocks based on PEC stages.

FIG. 9 is a flow diagram that illustrates an example method for managing a memory space in a memory system based on some embodiments of the disclosed technology.

FIG. 10 is a flow diagram that illustrates another example method for managing a memory space in a memory system based on some embodiments of the disclosed technology.

### DETAILED DESCRIPTION

Internal writes generated by the garbage collection process can adversely affect host read quality of service (QoS) and throughput. Write amplification (WA) refers to the phenomenon in which the amount of data actually written to the NAND flash memory of an SSD exceeds the amount of data requested to be written by the host. Since SSDs do not support in-place overwrites, new data must be written to a new location rather than overwriting the existing data. As a result, Garbage Collection (GC) is periodically triggered to reclaim memory space by merging valid data and erasing invalid data blocks. This process introduces additional internal write operations, which cause write amplification.

The severity of such interference is quantified by WA ratio:

WA ratio=NAND Writes/Host Writes

Higher WA ratio indicates more internal writes resulting from increased garbage collection (GC) activity. To enhance host read quality of service (QoS) and throughput performance, a lower WA is preferable. In particular, maintaining a low WA is especially beneficial during the beginning-of-life (BOL) and middle-of-life (MOL) phases, as these stages often impose stricter QoS and throughput requirements. In contrast, the end-of-life (EOL) stage generally tolerates some performance degradation, provided that the reliability of the memory system is maintained.

The disclosed technology can be implemented in some embodiments to provide memory space management techniques for reducing write amplification (WA) through dynamic allocation of XOR and reserved (RSVD) spaces during the lifetime of a memory system (e.g., SSD). Here, the memory space management techniques include NAND media space management techniques. In some embodiments, the term “media space” in an SSD refers to the total storage capacity available on the SSD. In some embodiments, the term “SSD” may be used to refer not only to solid state drives based on NAND flash memory, but also to memory systems based on any type of non-volatile memory.

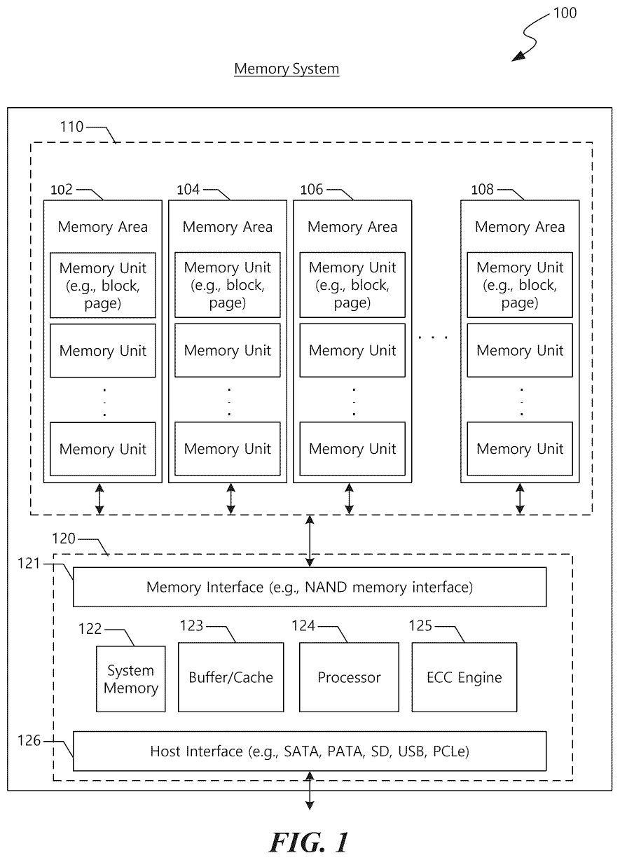

FIG. 1 illustrates an example of a memory system 100 that can be utilized for implementing some embodiments of the disclosed technology. The memory system 100 includes a memory module 110 that can be used to store information for use by other electronic devices or systems. The memory system 100 can be incorporated (e.g., located on a circuit board) in other electronic devices and systems. Alternatively, the memory system 100 can be implemented as an external storage device such as a USB flash drive and a solid-state drive (SSD).

The memory module 110 included in the memory system 100 can include memory areas (e.g., memory arrays) 102, 104, 106, and 108. Each of the memory areas 102, 104, 106, and 108 can be included in a single memory die or in multiple memory dice. The memory die can be included in an integrated circuit (IC) chip.

Each of the memory areas 102, 104, 106, and 108 includes a plurality of memory cells. Read, program, or erase operations can be performed on a memory unit basis. Thus, each memory unit can include a predetermined number of memory cells. The memory cells in a memory area 102, 104, 106, or 108 can be included in a single memory die or in multiple memory dice.

The memory cells in each of memory areas 102, 104, 106, and 108 can be arranged in rows and columns in the memory units. Each of the memory units can be a physical unit. For example, a group of a plurality of memory cells can form a memory unit. Each of the memory units can also be a logical unit. For example, the memory unit can be a bank, block, or page that can be identified by a unique address such as bank address, block address, and page basis address. During a read or write operation, the unique address associated with a particular memory unit can be used to access that particular memory unit. Based on the unique address, information can be written to or retrieved from one or more memory cells in that particular memory unit.

The memory cells in the memory areas 102, 104, 106, and 108 can include non-volatile memory cells. Examples of non-volatile memory cells include flash memory cells, phase change memory (PRAM) cells, magnetoresistive random-access memory (MRAM) cells, or other types of non-volatile memory cells. In an example implementation where the memory cells are configured as NAND flash memory cells, the read or write operation can be performed on a page basis. However, an erase operation in a NAND flash memory is performed on a block basis.

Each of the non-volatile memory cells can be configured as a single-level cell (SLC) or multiple-level memory cell. A single-level cell can store one bit of information per cell. A multiple-level memory cell can store more than one bit of information per cell. For example, each of the memory cells in the memory areas 102, 104, 106, and 108 can be configured as a multi-level cell (MLC) to store two bits of information per cell, a triple-level cell (TLC) to store three bits of information per cell, or a quad-level cells (QLC) to store four bits of information per cell. In another example, each of the memory cells in memory area 111 can be configured to store at least one bit of information (e.g., one bit of information or multiple bits of information), and each of the memory cells in memory area 112 can be configured to store more than one bit of information.

As shown in FIG. 1, the memory system 100 includes a controller module 120. The controller module 120 includes a memory interface 121 to communicate with the memory module 110, a host interface 126 with communicate with a host (not shown), a processor 124 to executes firmware-level code, and buffers/caches and memories 122 and 123 to temporarily or persistently store executable firmware/instructions and associated information. In some implementations, the controller unit 120 can include an error correction engine 125 to perform error correction operation on information stored in the memory module 110. Error correction engine 122 can be configured to detect/correct single bit error or multiple bit errors. In another implementation, error correction engine 125 can be located in the memory module 110.

In some implementations, the controller module 120 can also include a host interface 126 to communicate with the host. Host interface 126 can include components that comply with at least one of host interface specifications, including but not limited to, Serial Advanced Technology Attachment (SATA), Serial Attached Small Computer System Interface (SAS) specification, Peripheral Component Interconnect Express (PCIe).

The controller module 120 may include an error correction code (ECC) engine 125 that is configured to receive data to be written to the plurality of memory areas 102, 104, 106, 108 and to generate a codeword. For example, the ECC engine 125 may include an encoder configured to encode data using error correction codes such as a low-density parity check (LDPC) encoder.

The ECC engine 125 may also be configured to receive data and to process the received data using the error correction codes such as the LDPC decoder. The LDPC decoder may be configured to decode data read from the plurality of memory areas 102, 104, 106, 108 to detect and correct, up to an error correction capability of the ECC scheme, one or more bits of errors that are present in the data.

Memory media space (e.g., NAND media space) management techniques implemented based on some embodiments can reduce WA during the BOL and MOL stages, as will be discussed below.

In an embodiment, the memory media space management techniques include an XOR recovery optimization method that includes applying different XOR recovery schemes based on program/erase cycle (PEC) counts. This allows for reduced XOR space usage during BOL and MOL, with the reclaimed space reallocated for garbage collection, thereby lowering WA.

In another embodiment, the memory media space management techniques include an XOR dynamic reserved space management method that includes dynamically managing reserved (RSVD) space for bad blocks according to PEC progression.

In some implementations, the term “XOR space” refers to an area within the memory system (e.g., SSD) used to store parity information for data recovery. In some implementations, the term “reserved (RSVD) space” refers to a memory space reserved within the memory system (e.g., SSD) to manage bad blocks and ensure reliability.

The XOR recovery optimization method and the XOR dynamic reserved space management method can be applied independently or in combination for enhanced WA reduction.

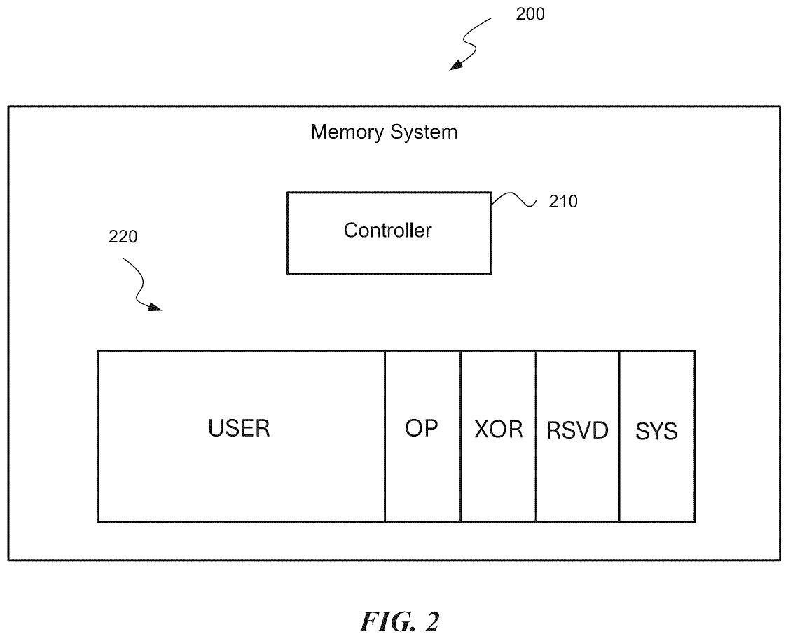

FIG. 2 is a schematic diagram illustrating an example of a memory system based on some embodiments of the disclosed technology. Specifically, FIG. 2 shows an example partitioning of a memory space (e.g., memory media space) 220 in a memory system 200 (e.g., NAND media space in an SSD), including USER, OP, XOR, RSVD, and SYS spaces.

Referring to FIG. 2, the entire NAND media space 210 is generally divided into five regions: (1) USER space stores user data; (2) OP (overprovisioned) space includes spare blocks used for garbage collection (GC); (3) XOR space is allocated for XOR parity data used in error recovery; (4) RSVD (Reserved) space is reserved for replacing bad blocks; (5) SYS (System) space stores system-related data, such as firmware (FW) images. In some embodiments of the disclosed technology, the term “functional memory space” can be used to indicate these regions of NAND media space.

In some embodiments, the memory system 200 may include a controller 210 in communication with the memory space 220 to: monitor a usage condition of the memory space 200; determine a current wear level stage of the memory system 200, from among a plurality of predetermined memory wear stages; select an error correction granularity level corresponding to the determined memory wear stage; and perform an error correction operation based on the error correction granularity level.

In FIG. 2, by way of example, the controller 210 is shown as being within the memory system 200. However, in other examples, the controller 210 may be located outside the memory system 200.

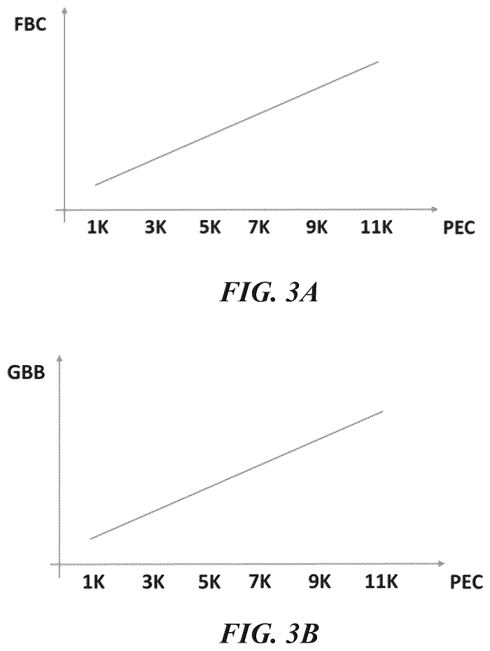

FIG. 3A is a graph showing the increase in fail bit count (FBC) across program/erase cycle (PEC) stages. FIG. 3B is a graph showing the increase in grown bad blocks (GBBs) across program/erase cycle (PEC) stages.

In some memory systems such as SSDs, this allocation is determined at power-on and remains fixed throughout the lifetime of the memory system. RSVD and XOR spaces are conservatively reserved to ensure end-of-life (EOL) reliability, even during the beginning-of-life (BOL) stage.

However, as shown in FIG. 3A, the fail bit count (FBC) of memory areas (e.g., NAND flash memory) gradually increases with program/erase cycles (PECs). When the FBC exceeds the correction capability of the error correction code, uncorrectable ECC (UECC) errors occur. Similarly, as illustrated in FIG. 3B, the number of grown bad blocks (GBBs) increases with PECs. These trends suggest that, during the BOL and middle-of-life (MOL) stages, e.g., when the likelihood of UECC and GBB occurrences is relatively low, smaller RSVD and XOR allocations are sufficient to maintain reliability.

By reducing RSVD and XOR allocations during the BOL and MOL stages, the reclaimed space can be reallocated to the OP region to improve garbage collection efficiency. As a result, WA can be lowered in these stages, leading to enhanced SSD quality of service (QoS), throughput, and endurance.

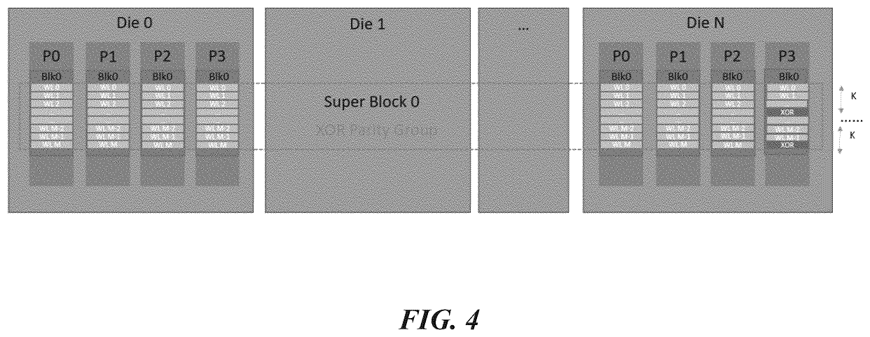

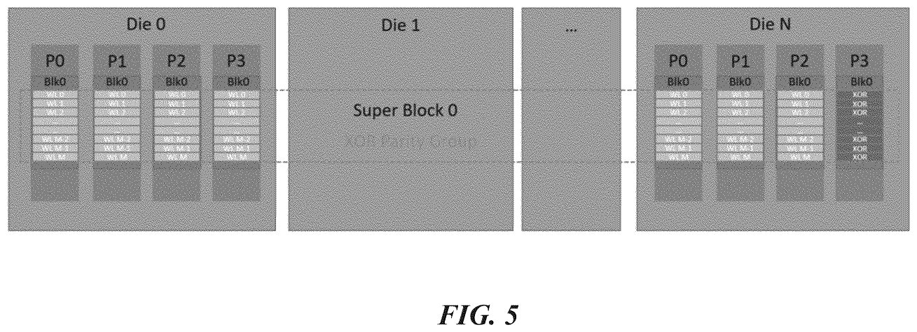

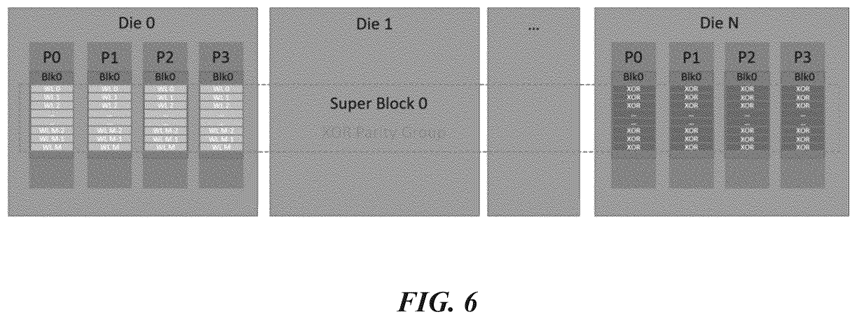

FIG. 4 is a conceptual diagram of a wordline XOR scheme applied during the beginning-of-life (BOL) PEC stage. FIG. 5 is a conceptual diagram of a plane XOR scheme applied during the middle-of-life (MOL) PEC stage. FIG. 6 is a conceptual diagram of a die XOR scheme applied during the end-of-life (EOL) PEC stage.

### Method 1: Reducing Write Amplification (WA) Through XOR Space Management

As explained above, the memory media space management techniques include the XOR recovery optimization method.

In some example SSD designs, a fixed amount of XOR space is allocated throughout the entire lifetime of the device to ensure data reliability. In an embodiment of the disclosed technology, a dynamic XOR space allocation is used to adjust an allocation of XOR space based on the program/erase cycle (PEC) stage, thereby enabling more efficient use of XOR space, particularly during the beginning-of-life (BOL) and middle-of-life (MOL) stages, where NAND degradation is relatively limited.

In some embodiments, the dynamic XOR space allocation includes different XOR schemes that are applied at the superblock (SB) level, which includes N+1 dies such that each die includes 4 planes and each plane includes M+1 wordlines (WLs). While each WL includes multiple pages, page-level details are omitted here for simplicity.

In some embodiments, the overall program/erase cycle (PEC) range of the NAND flash memory is divided into multiple stages or zones to reflect the progressive wear of the memory cells. In some embodiments, the term “zone” refers to a range of PEC counts that characterize a wear level stage of the memory cells. These PEC zones serve as a basis for dynamically adjusting resource allocations such as XOR parity space and reserved (RSVD) space. The zones are defined as follows:

The beginning-of-life (BOL) stage corresponds to a PEC range of (0, P₀), where P₀ represents a first PEC threshold (e.g., X cycles). During this stage, the memory system exhibits low error rates and minimal growth of bad blocks. Referring to FIGS. 3A-3B, for example, the first PEC threshold may correspond to 1000 cycles, 3000 cycles, or 5000 cycles. For example, the BOL stage may correspond to a PEC range of 0 to 1000 cycles, 0 to 3000 cycles, or 0 to 5000 cycles.

The middle-of-life (MOL) stage corresponds to a PEC range of (P₀, P₁), where P₁ is a second PEC threshold (e.g., Y cycles, Y>X). At this stage, the NAND has begun to degrade, with a moderate increase in error rates and bad block occurrences. Referring to FIGS. 3A-3B, for example, the second PEC threshold may correspond to 5000 cycles, 7000 cycles, or 9000 cycles. For example, the MOL stage may correspond to a PEC range of 1000 to 3000 cycles, 1000 to 5000 cycles, 1000 to 7000 cycles, 1000 to 9000 cycles, 3000 to 5000 cycles, 3000 to 7000 cycles, or 3000 to 9000 cycles.

The end-of-life (EOL) stage corresponds to a PEC range of (P₁, P₂), where P₂ is the maximum expected PEC (e.g., Z cycles, Z>Y). In this final stage, the memory media space experiences the highest level of degradation, requiring maximum redundancy and reserved resources to maintain data reliability. Referring to FIGS. 3A-3B, for example, the third PEC threshold may correspond to 7000 cycles, 9000 cycles, or 11000 cycles. For example, the EOL stage may correspond to a PEC range of 3000 to 5000 cycles, 3000 to 7000 cycles, 3000 to 9000 cycles, 3000 to 11000 cycles, 5000 to 7000 cycles, 5000 to 9000 cycles, 5000 to 11000 cycles, 7000 to 9000 cycles, 7000 to 11000 cycles, or 9000 to 11000 cycles.

As will be discussed below, these PEC-based zones enable a memory system controller to apply different XOR schemes according to the wear level of the NAND, thereby optimizing resource utilization and reducing write amplification.

1. BOL Stage with PEC in Zone (0, P₀)

During the BOL stage, a wordline XOR scheme is used (see FIG. 4). Parity is applied only to weak wordlines, e.g., those identified as having higher error susceptibility than a threshold error susceptibility through characterization tests (e.g., NAND characterization tests).

Each plane is divided into (M+1)/K regions such that each region can correct errors resulting from one weak WL. Each parity can correct errors resulting from K WLs across 4 planes in N+1 dies. The wordline XOR scheme requires minimal XOR space, approximately K/(M+1) of the space used in the plane XOR scheme, which will be discussed below. This level of protection is sufficient due to the lower error rates during BOL.

2. MOL Stage with PEC in Zone (P₀, P₁)

In the MOL stage, due to the increased wear on the memory media space, an increased amount of XOR space is required. As the memory system enters the MOL stage, with PEC counts falling between thresholds P₀ and P₁, the controller transitions to a plane-level XOR scheme (see FIG. 5). One parity is calculated from all (N+1)×4-1 planes and stored in the last plane of the SB, allowing for recovery from an entire plane failure. It requires a moderate amount of XOR space, more than the BOL scheme but less than the EOL scheme.

3. EOL Stage with PEC in Zone (P₁, P₂)

In the EOL stage, when the PEC count exceeds threshold P₁, the controller activates a die-level XOR scheme to enable data recovery even in the event of a full die failure (see FIG. 6). Parity is calculated across the same WL and same plane across the previous N dies of the SB. All parity data is stored in the (N+1)th die of the SB. This scheme enables recovery from full die failures and requires the largest XOR space. The die XOR parity size is approximately four times that of the plane XOR scheme in the example illustrated in FIG. 6.

XOR configurations with finer granularity (e.g., wordline XOR) require less space but provide narrower error correction coverage. Accordingly, the dynamic XOR space allocation allows the memory system to respond flexibly to the gradual wear of NAND flash throughout its lifespan.

In some implementations, the wordline XOR scheme groups a limited number of wordlines across multiple planes and dies, and calculates XOR parity over these selected wordlines. In some implementations, the plane XOR scheme calculates XOR parity over multiple planes to compute a parity plane. For example, Nx4-1 planes (assuming N dies, each die includes 4 planes) may be XORed together to generate a parity plane, which is stored in a reserved location within the same superblock. This allows recovery from a full-plane failure. In some implementations, the die-level XOR scheme calculates XOR parity data from the same physical location (e.g., same wordline and plane index) across multiple dies, and the resulting parity is stored in a dedicated die or reserved region.

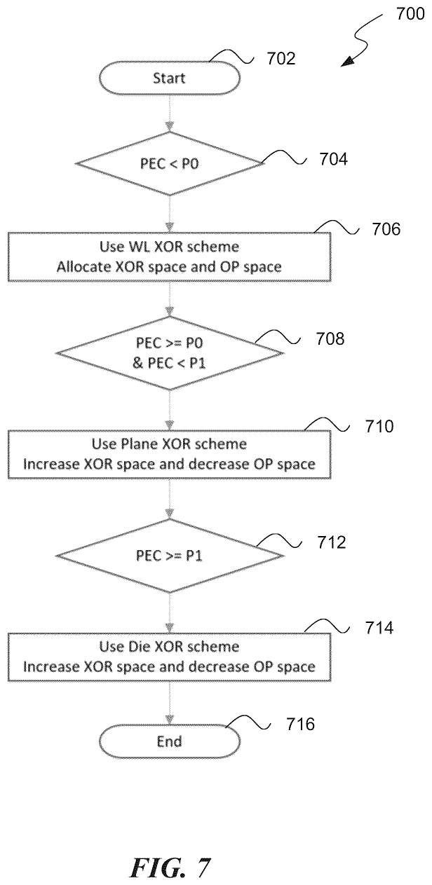

FIG. 7 is a flowchart illustrating a method of dynamically managing XOR space in accordance with PEC progression.

Specifically, FIG. 7 shows a method 700 for adaptively selecting an XOR scheme and managing overprovisioned (OP) space in a memory system (e.g., NAND-based SSD) according to the program/erase count (PEC), which is an indicator of the aging state of memory blocks (e.g., NAND memory blocks) in the memory system. Referring to FIG. 7, the process begins by evaluating the current PEC of a block (702). If the PEC is less than a predefined threshold P₀ (704), the system applies a word line (WL)-level XOR scheme (706). In this early stage of the NAND lifecycle, wear is minimal, so both XOR space and OP space are allocated in moderate amounts to balance performance and reliability. When the PEC enters the middle lifecycle region, between thresholds P₀ and P₁ (708), the system switches to a plane-level XOR scheme (710), expanding the XOR space. In this case, to accommodate the increased redundancy requirement, the OP space is reduced. For blocks with high PECs, exceeding P₁ (712), the system switches to a die-level XOR scheme for maximum data recovery capability (714). In this case, XOR space is further increased, and OP space is further decreased.

The XOR space saved during BOL and MOL, compared to the EOL allocation, is dynamically reclaimed by the firmware (FW) and reallocated to the overprovisioned (OP) space, which refers to the portion of NAND flash memory that is reserved for specific purposes and is not accessible by the host system. This expanded OP space can be used for garbage collection, thus reducing WA.

Simulation examples that quantify the potential WA reduction can illustrate the effectiveness of the disclosed technology. Assuming each die contains 4 planes and each block includes 100 wordlines (WLs), a superblock (SB) stripe includes blocks from 16 dies, corresponding to N=15, M=99, and K=4 in the XOR scheme description. Therefore, each SB includes a total of 64 blocks.

For the WL XOR scheme, as illustrated in FIG. 4, only 25 WLs are allocated as XOR parity pages per SB. The required XOR space for each of the different XOR schemes can be calculated, as summarized in Table 1.

TABLE 1
XOR Space for different XOR schemes

| XOR Scheme | WL XOR | Plane XOR | Die XOR |
|---|---|---|---|
| USER Space | 200 SB | 200 SB | 200 SB |
| OP Space | 39 SB | 36 SB | 26 SB |
| XOR Space | 1 SB | 4 SB | 14 SB |
| RSVD Space | 10 SB | 10 SB | 10 SB |
| SYS Space | 5 SB | 5 SB | 5 SB |

The write amplification (WA) values under a random write workload are summarized in Table 2. WA is significantly reduced during the beginning-of-life (BOL) and middle-of-life (MOL) stages when compared to the end-of-life (EOL) baseline, which has a WA of 5.08.

TABLE 2
WA Reduction with Dynamic XOR Space Management

| PEC Stage | BOL | MOL | EOL |
|---|---|---|---|
| PEC Zone | (0, P₀), e.g., | (P₀, P₁), e.g., | (P₁, P₂), e.g., |
| | (0, 3K) | (3K, 6K) | (6K, 9K) |
| XOR Scheme | WL XOR | Plane XOR | Die XOR |
| WA | 3.36 | 3.64 | 5.08 |

### Method 2: Dynamic Reserved (RSVD) Space Management

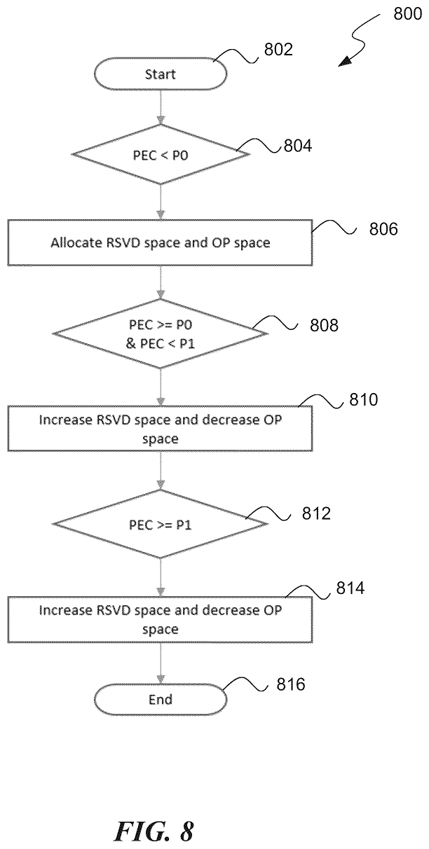

FIG. 8 is a flowchart illustrating a method of dynamically managing reserved (RSVD) space for bad blocks based on PEC stages.

Specifically, FIG. 8 shows a method 800 for dynamically adjusting reserved (RSVD) space and overprovisioned (OP) space in a NAND flash-based SSD according to the program/erase count (PEC), which indicates the aging state of memory blocks. Referring to FIG. 8, the process begins by determining the PEC of a given block or superblock (802). When the PEC is below the first threshold P₀ (804), the system allocates an initial amount of RSVD space and OP space (806). In this early stage of the NAND lifecycle, minimal reserved space is sufficient for handling bad block replacement and error recovery, while a relatively large OP space is preserved for performance optimization. When the PEC enters the middle lifecycle region, between thresholds P₀ and P₁ (808), the controller increases the RSVD space to prepare for higher error rates and defect occurrence, and to accommodate this increase, the OP space is decreased (810). In the final stage of the NAND lifecycle, the controller further increases the RSVD space to ensure data reliability, and the OP space is further reduced (814).

In this way, the controller can flexibly allocate internal resources based on stage of the corresponding stage of the NAND lifecycle. By gradually expanding RSVD space and reducing OP space, the system can enhance garbage collection efficiency, thus reducing WA.

### Method 2: Reducing Write Amplification Through Dynamic RSVD Space Management

In some example SSD designs, a static reserved (RSVD) space is allocated throughout the entire lifetime of the device. As the number of bad blocks (GBBs) increases, the firmware (FW) replaces them using blocks from the pre-allocated RSVD space. These reserved blocks remain preserved in the RSVD pool until they are required for replacement.

However, since bad blocks typically increase gradually with program/erase cycles (PECs), this static allocation is inefficient, particularly during the early stages of the NAND lifecycle. As will be discussed below, to address this issue, the disclosed technology can be implemented in some embodiments to provide a dynamic RSVD space management method, where the amount of reserved space varies depending on the corresponding PEC stage. The RSVD space saved during the beginning-of-life (BOL) and middle-of-life (MOL) stages is reallocated to the overprovisioned (OP) space, thereby improving garbage collection (GC) efficiency and reducing write amplification (WA).

1. BOL Stage with PEC in Zone (0, P₀)

In this stage, only a small number of bad blocks are expected. Therefore, a minimal RSVD space is used, including R_BOL superblocks (e.g., R_BOL=3).

2. MOL Stage with PEC in Zone (P₀, P₁)

In the MOL stage, NAND wear increases, a moderate amount of RSVD space is required, and thus RSVD space including R_MOL superblocks is used for this stage (e.g., R_MOL=6).

3. EOL Stage with PEC in Zone (P₁, P₂)

In the EOL stage, when the PEC count exceeds threshold P₁, the risk of bad block growth becomes more significant. Therefore, a larger RSVD space is required, and thus RSVD space including R_EOL superblocks is used for this stage (e.g., R_EOL=10).

By dynamically adjusting RSVD allocation across these life stages, NAND space utilization can be improved. The space saved during BOL and MOL is reassigned to OP space, enabling more efficient garbage collection and lowering WA during these stages.

Assuming that the total number of super blocks in OP space and RSVD space is 36, as shown in Table 3, for the BOL, 3 SBs are used for RSVD space, and for MOL and EOL, 6 SBs and 10 SBs are used respectively. The WA under random-write workload is shown in Table 3. As shown in Table 3, WA is significantly reduced at BOL and MOL, compared to EOL WA 5.08.

TABLE 3
WA Reduction with Dynamic RSVD Space Management

| PEC Stage | BOL | MOL | EOL |
|---|---|---|---|
| PEC Zone | (0, P₀) | (P₀, P₁) | (P₁, P₂) |
| USER Space | 200 SB | 200 SB | 200 SB |
| OP Space | 33 SB | 30 SB | 26 SB |
| XOR Space | 14 SB | 14 SB | 14 SB |
| RSVD Space | 3 SB | 6 SB | 10 SB |
| SYS Space | 5 SB | 5 SB | 5 SB |
| WA | 4.12 | 4.47 | 5.08 |

In the methods described above, the entire program/erase cycle (PEC) range is divided into three zones: beginning-of-life (BOL), middle-of-life (MOL), and end-of-life (EOL). However, the disclosed technology is not limited thereto. In some embodiments, the PEC range may be divided into M zones (M is a positive integer), allowing finer control over resource allocation.

The XOR space management method and RSVD space management method discussed above can be applied independently or in combination. When implemented jointly, the flowcharts illustrated in FIG. 7 (XOR management) and FIG. 8 (RSVD management) can be combined. Specifically, once the current PEC zone is determined, both XOR and RSVD spaces can be dynamically allocated according to the reliability requirements of the corresponding zone. The remaining NAND space is then recalculated and assigned to the overprovisioned (OP) region. This combined method of XOR space management and RSVD space management allows the SSD to adaptively balance reliability and performance throughout its lifetime, achieving optimal WA reduction.

In some embodiments, to enable the dynamic space management methods discussed above, a controller (e.g., SSD controller) maintains block- or superblock-level PEC (program/erase cycle) information. This data is used to determine when and how to adjust the allocation of XOR and RSVD spaces throughout the lifecycle of the memory system (e.g., SSD).

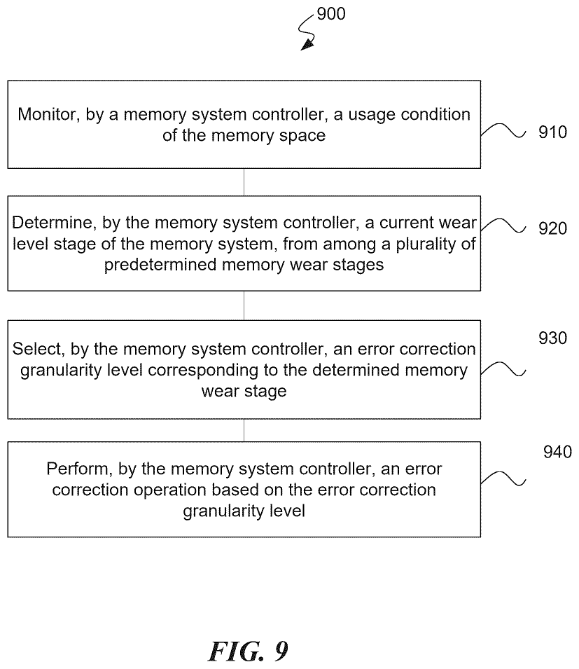

FIG. 9 is a flow diagram that illustrates an example method 900 for managing a memory space in a memory system based on some embodiments of the disclosed technology.

The method 900 includes, at 910, monitoring, by a memory system controller, a usage condition of the memory space; at 920, determining, by the memory system controller, a current wear level stage of the memory system, from among a plurality of predetermined memory wear stages; at 930, selecting, by the memory system controller, an error correction granularity level corresponding to the determined memory wear stage; and, at 940, performing, by the memory system controller, an error correction operation based on the error correction granularity level

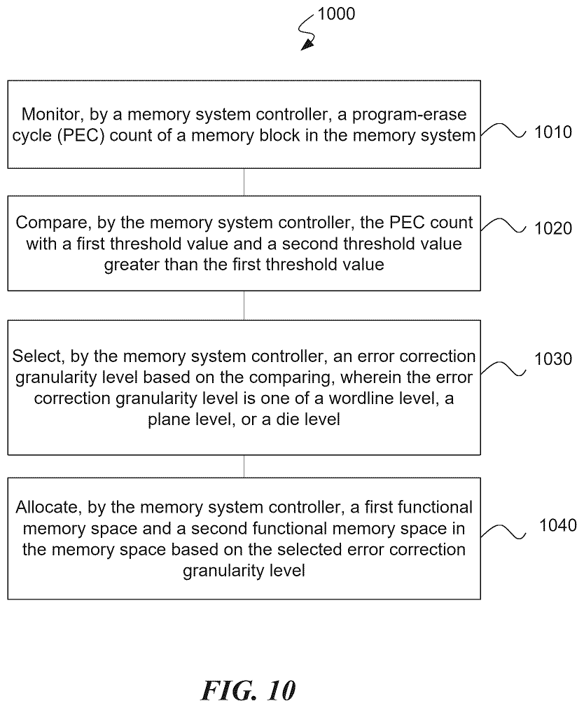

FIG. 10 is a flow diagram that illustrates another example method 1000 for managing a memory space in a memory system based on some embodiments of the disclosed technology.

The method 1000 includes, at 1010, monitoring, by a memory system controller, a program-erase cycle (PEC) count of a memory block in the memory system; at 1020, comparing, by the memory system controller, the PEC count with a first threshold value and a second threshold value greater than the first threshold value; at 1030, selecting, by the memory system controller, an error correction granularity level based on the comparing, wherein the error correction granularity level is one of a wordline level, a plane level, or a die level; and, at 1040, allocating, by the memory system controller, a first functional memory space and a second functional memory space in the memory space based on the selected error correction granularity level.

Therefore, various implementations of features of the disclosed technology can be made based on the above disclosure, including the examples listed below.
Example 1. A method for managing a memory space in a memory system, comprising: monitoring, by a memory system controller, a usage condition of the memory space; determining, by the memory system controller, a current wear level stage of the memory system, from among a plurality of predetermined memory wear stages; selecting, by the memory system controller, an error correction granularity level corresponding to the determined memory wear stage; and performing, by the memory system controller, an error correction operation based on the error correction granularity level.
Example 2. The method of example 1, wherein the usage condition comprises a program-erase cycle (PEC) count of the memory system.
Example 3. The method of example 1, wherein the error correction granularity level indicates whether error correction is to be applied: at a wordline level to correct errors resulting from a wordline failure in a superblock of the memory system; at a plane level to correct errors resulting from a plane failure in the superblock of the memory system; or at a die level to correct errors resulting from a die failure in the superblock of the memory system.
Example 4. The method of example 1, wherein the plurality of predetermined memory wear stages includes a beginning-of-life (BOL) stage, a middle-of-life (MOL) stage, and an end-of-life (EOL) stage.
Example 5. The method of example 4, wherein the error correction operation based on the error correction granularity level includes: a wordline-level error correction operation used in the BOL stage; a plane-level error correction operation used in the MOL stage, or a die-level error correction operation used in the EOL stage, wherein the wordline-level error correction operation calculates XOR parity over selected wordlines, wherein the plane-level error correction operation calculates XOR parity data from a same physical location across multiple planes, and wherein the die-level error correction operation calculates XOR parity data from a same physical location across multiple dies.
Example 6. The method of example 1, wherein the memory space includes at least one of: a user data space configured to store user data; an overprovisioned (OP) space configured for garbage collection use; an error correction code space configured to store parity information; a reserved space for defective memory replacement; or a system space configured to store system-related data.
Example 7. The method of example 6, wherein the error correction code space includes an XOR parity data space, and wherein the method further comprises: allocating a portion of the XOR parity data space in accordance with the error correction operation; and reallocating an unused portion of the XOR parity space to an overprovisioned (OP) space to reduce write amplification.
Example 8. The method of example 1, wherein the plurality of predetermined memory wear stages includes a beginning-of-life (BOL) stage, a middle-of-life (MOL) stage, and an end-of-life (EOL) stage, and wherein the method further comprises: allocating a first functional memory space and a second functional memory space in the memory space based on a particular stage of the plurality of predetermined memory wear stages that includes: upon a determination that the memory system is in the BOL stage, performing an error correction at a wordline level, and allocating a first ratio of the first functional memory space to the second functional memory space; upon a determination that the memory system is in the MOL stage, performing the error correction at a plane level, and allocating a second ratio of the first functional memory space to the second functional memory space; and upon a determination that the memory system is in the EOL stage, performing the error correction at a die level, and allocating a third ratio of the first functional memory space to the second functional memory space.
Example 9. The method of example 8, wherein the first functional memory space includes an error correction code space configured to store XOR parity data and the second functional memory space includes an over-provisioning (OP) space.
Example 10. The method of example 8, wherein the first functional memory space includes a reserved (RSVD) space configured to replace bad blocks and the second functional memory space includes an over-provisioning (OP) space.
Example 11. A method for managing a memory space in a memory system, comprising: monitoring, by a memory system controller, a program-erase cycle (PEC) count of a memory block in the memory system; comparing, by the memory system controller, the PEC count with a first threshold value and a second threshold value greater than the first threshold value; selecting, by the memory system controller, an error correction granularity level based on the comparing, wherein the error correction granularity level is one of a wordline level, a plane level, or a die level; and allocating, by the memory system controller, a first functional memory space and a second functional memory space in the memory space based on the selected error correction granularity level.
Example 12. The method of example 11, wherein the first functional memory space includes an error correction code space configured to store XOR parity data and the second functional memory space includes an over-provisioning (OP) space.
Example 13. The method of example 11, wherein the first functional memory space includes a reserved (RSVD) space configured to replace bad blocks and the second functional memory space includes an over-provisioning (OP) space.
Example 14. The method of example 11, wherein: in response to the PEC count being less than the first threshold value, an error correction is performed at the wordline level, and the allocating includes allocating a first ratio of the first functional memory space to the second functional memory space; in response to the PEC count being greater than or equal to the first threshold value and less than the second threshold value, the error correction is performed at the plane level, and the allocating includes allocating a second ratio of the first functional memory space to the second functional memory space is allocated; and in response to the PEC count being greater than or equal to the second threshold value, the error correction is performed at the die level, and the allocating includes allocating a third ratio of the first functional memory space to the second functional memory space is allocated.
Example 15. The method of example 14, wherein the second ratio includes a larger XOR space compared to the first ratio and a smaller over-provisioning (OP) space compared to the first ratio, and the third ratio includes a larger XOR space compared to the second ratio and a smaller OP space compared to the second ratio.
Example 16. A memory system, comprising: a memory space including a plurality of functional memory spaces allocated for specific functionalities; and a controller in communication with the memory space to: monitor a usage condition of the memory space; determine a current wear level stage of the memory system, from among a plurality of predetermined memory wear stages; select an error correction granularity level corresponding to the determined memory wear stage; and perform an error correction operation based on the error correction granularity level.
Example 17. The memory system of example 16, wherein the usage condition comprises a program-erase cycle (PEC) count of the memory system.
Example 18. The memory system of example 16, wherein the plurality of predetermined memory wear stages includes a beginning-of-life (BOL) stage, a middle-of-life (MOL) stage, and an end-of-life (EOL) stage, wherein the plurality of functional memory spaces is configured to include a first functional memory space and a second functional memory space, and wherein the controller is configured to: upon a determination that the memory system is in the BOL stage, perform the error correction operation at a wordline level, and allocate a first ratio of the first functional memory space to the second functional memory space; upon a determination that the memory system is in the MOL stage, perform the error correction operation at a plane level, and allocate a second ratio of the first functional memory space to the second functional memory space; and upon a determination that the memory system is in the EOL stage, perform the error correction operation at a die level, and allocate a third ratio of the first functional memory space to the second functional memory space.
Example 19. The memory system of example 18, wherein the first functional memory space includes an error correction code space configured to store XOR parity data and the second functional memory space includes an over-provisioning (OP) space.
Example 20. The memory system of example 18, wherein the first functional memory space includes a reserved (RSVD) space configured to replace bad blocks and the second functional memory space includes an over-provisioning (OP) space.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “processor” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for managing a memory space in a memory system, comprising:
monitoring, by a memory system controller, a usage condition of the memory space, wherein the memory space includes a reserved space configured to replace bad blocks and an overprovisioned space configured for garbage collection;
determining, by the memory system controller, a current wear level stage of the memory system, from among a plurality of predetermined memory wear stages;
selecting, by the memory system controller, an error correction granularity level corresponding to the determined current wear level stage;
performing, by the memory system controller, an error correction operation based on the error correction granularity level; and
allocating, by the memory system controller, the reserved space and the overprovisioned space at an allocation ratio of the reserved space to the overprovisioned space according to the determined current wear level stage.

2. The method of claim 1, wherein the usage condition comprises a program-erase cycle (PEC) count of the memory system.

3. The method of claim 1, wherein the error correction granularity level indicates whether error correction is to be applied: at a wordline level to correct errors resulting from a wordline failure in a superblock of the memory system; at a plane level to correct errors resulting from a plane failure in the superblock of the memory system; or at a die level to correct errors resulting from a die failure in the superblock of the memory system.

4. The method of claim 1, wherein the plurality of predetermined memory wear stages includes a beginning-of-life (BOL) stage, a middle-of-life (MOL) stage, and an end-of-life (EOL) stage.

5. The method of claim 4, wherein the error correction operation based on the error correction granularity level includes: a wordline-level error correction operation used in the BOL stage; a plane-level error correction operation used in the MOL stage, or a die-level error correction operation used in the EOL stage, wherein the wordline-level error correction operation calculates XOR parity over selected wordlines, wherein the plane-level error correction operation calculates XOR parity data from a same physical location across multiple planes, and wherein the die-level error correction operation calculates XOR parity data from a same physical location across multiple dies.

6. The method of claim 1, wherein the memory space further includes at least one of: a user data space configured to store user data; an error correction code space configured to store parity information; or a system space configured to store system-related data.

7. The method of claim 6, wherein the error correction code space includes an XOR parity data space, and wherein the method further comprises:
allocating a portion of the XOR parity data space in accordance with the error correction operation; and
reallocating an unused portion of the XOR parity space to the overprovisioned space to reduce write amplification.

8. The method of claim 1, wherein the plurality of predetermined memory wear stages includes a beginning-of-life (BOL) stage, a middle-of-life (MOL) stage, and an end-of-life (EOL) stage, and
wherein:
upon a determination that the memory system is in the BOL stage, the error correction operation is performed at a wordline level, and the allocation ratio is a first ratio;
upon a determination that the memory system is in the MOL stage, the error correction operation is performed at a plane level, and the allocation ratio is a second ratio greater than the first ratio; and
upon a determination that the memory system is in the EOL stage, the error correction operation is performed at a die level, and the allocation ratio is a third ratio greater than the second ratio.

9. The method of claim 8, further comprising allocating an error correction code space configured to store XOR parity data according to the determined current wear level stage.

10. (canceled)

11. A method for managing a memory space in a memory system, comprising:
monitoring, by a memory system controller, a program-erase cycle (PEC) count of a memory block in the memory system;
comparing, by the memory system controller, the PEC count with a first threshold value and a second threshold value greater than the first threshold value;
selecting, by the memory system controller, an error correction granularity level based on the comparing, wherein the error correction granularity level is one of a wordline level, a plane level, or a die level; and
allocating, by the memory system controller, a reserved space configured to replace bad blocks and an overprovisioned space in the memory space according to an allocation ratio of the reserved space to the overprovisioned space that is determined based on the comparing.

12. The method of claim 11, wherein the memory space includes an error correction code space configured to store XOR parity data.

13. (canceled)

14. The method of claim 11, wherein:
in response to the PEC count being less than the first threshold value, an error correction is performed at the wordline level, and the allocation ratio is a first ratio;
in response to the PEC count being greater than or equal to the first threshold value and less than the second threshold value, the error correction is performed at the plane level, and the allocation ratio is a second ratio greater than the first ratio; and
in response to the PEC count being greater than or equal to the second threshold value, the error correction is performed at the die level, and the allocation ratio is a third ratio greater than the second ratio.

15. (canceled)

16. A memory system, comprising:
a memory space including a plurality of functional memory spaces allocated for specific functionalities, the plurality of functional memory spaces including a reserved space configured to replace bad blocks and an overprovisioned space configured for garbage collection; and
a controller in communication with the memory space to:
monitor a usage condition of the memory space;
determine a current wear level stage of the memory system, from among a plurality of predetermined memory wear stages;
select an error correction granularity level corresponding to the determined current wear level stage;
perform an error correction operation based on the error correction granularity level; and
allocate the reserved space and the overprovisioned space at an allocation ratio of the reserved space to the overprovisioned space according to the determined current wear level stage.

17. The memory system of claim 16, wherein the usage condition comprises a program-erase cycle (PEC) count of the memory system.

18. The memory system of claim 16, wherein the plurality of predetermined memory wear stages includes a beginning-of-life (BOL) stage, a middle-of-life (MOL) stage, and an end-of-life (EOL) stage, and
wherein the controller is configured to:
upon a determination that the memory system is in the BOL stage, perform the error correction operation at a wordline level, and set the allocation ratio to a first ratio;
upon a determination that the memory system is in the MOL stage, perform the error correction operation at a plane level, and set the allocation ratio to a second ratio greater than the first ratio; and
upon a determination that the memory system is in the EOL stage, perform the error correction operation at a die level, and set the allocation ratio to a third ratio greater than the second ratio.

19. The memory system of claim 18, wherein the plurality of functional memory spaces includes an error correction code space configured to store XOR parity data.

20. (canceled)
